(19) United States
(12) Patent Application Publication
(10) Pub. No.: US 2025/0306911 A1
(43) Pub. Date: Oct. 2, 2025

(54) METHOD FOR UPDATING A PROGRAM IN A MICROCONTROLLER

(71) Applicant: STMicroelectronics International N.V., Geneva (CH)

(72) Inventor: Christophe ARNAL, Saint Vallier de Thiey (FR)

(73) Assignee: STMicroelectronics International N.V., Geneva (CH)

(21) Appl. No.: 19/083,926

(22) Filed: Mar. 19, 2025

(30) Foreign Application Priority Data
Mar. 26, 2024 (FR) FR2402992

(51) Int. Cl. G06F 8/654; G06F 12/12

(52) U.S. Cl. CPC G06F 8/654; G06F 12/12

(57) ABSTRACT

A microcontroller includes a memory storing a program which contains a first version of a first download protocol into the microcontroller and a first version of an application. The program is to be updated, with the update containing a second download protocol and a second version of the application. To perform the update, the first version of the application is erased from a first region of the memory. Then, the second download protocol is downloaded into the first region by using the first version of the first download protocol present in a second region of the memory. The content of the second region is then erased. The second version of the application is then downloaded by using the second download protocol.

### PRIORITY CLAIM

This application claims the priority benefit of French Application for U.S. Pat. No. 2,402,992, filed on Mar. 26, 2024, the content of which is hereby incorporated by reference in its entirety to the maximum extent allowable by law.

### TECHNICAL FIELD

The present disclosure generally concerns methods for updating a program in a microcontroller and microcontrollers implementing such methods.

### BACKGROUND

Certain microcontrollers use a program to implement wireless updates. This program must itself be able to be updated in wireless fashion.

However, current update methods require too much memory space.

There exists a need to provide a method for updating in wireless fashion a program of a microcontroller, which can limit the use of memory space of the microcontroller.

An embodiment overcomes all or part of the disadvantages of known methods.

### SUMMARY

An embodiment provides a method for updating a program in a microcontroller, the program to be updated containing a first version of a first download protocol into the microcontroller and a first version of an application and the update containing a second download protocol and a second version of the application, the method comprising: erasing the first version of the application from a first region; downloading, into the first region, the second download protocol by using the first version of the first download protocol present in a second region; erasing content from the second region; downloading the second version of the application by using the second download protocol.

An embodiment provides a microcontroller comprising a program containing a first version of a first download protocol into the microcontroller and a first version of an application, the microcontroller being configured to: erase the first version of the application from a first region; download, into the first region, a second download protocol by using the first version of the first download protocol present in a second region; erase the content of the second region; download a second version of the application by using the second download protocol.

In an embodiment, the downloading of the second version of the application is performed into the second region.

In an embodiment, after the erasing of the content of the second region and before the downloading of the second version of the application, transferring the content of the first region to the second region and then erasing the content of the first region.

In an embodiment, the downloading of the second version of the application is performed into the first region.

In an embodiment, the first and the second regions are regions of a memory of the microcontroller.

In an embodiment, said memory has a size smaller than the sum of the size of the first and second versions of the first download protocol.

In an embodiment, the first version of the download protocol or the second download protocol comprises a wireless update download protocol as well as a wireless communication protocol.

In an embodiment, the wireless update download protocol as well as the wireless communication protocol are configured so as to, when an update is requested, be fully executable without calling on elements contained in the first region.

In an embodiment, the wireless communication protocol is configured so as to, during the execution of the application, call on elements from a region different from that in which it is stored.

In an embodiment, said elements are portions of the wireless communication protocol which are not necessary during an update.

In an embodiment, said second region is delimited by at least two addresses in the memory.

In an embodiment, the second region comprises a plurality of non-contiguous segments of the memory, each delimited by at least two memory addresses.

In an embodiment, a processing unit of the microcontroller is configured to, when an update is requested, execute instructions of the download protocol written in the second region.

In an embodiment, said first region is delimited by at least two memory addresses.

In an embodiment, the first region comprises a plurality of non-contiguous segments of the memory, each delimited by at least two memory addresses.

In an embodiment, a processing unit of the microcontroller is configured to, when an update is requested, execute instructions of the download protocol written in the first region.

In an embodiment, the program to be updated is in the form of a first binary image containing the first version of the first download protocol and the first version of the application; and the update is in the form of a second binary image containing the second download protocol and the second version of the application.

In an embodiment, the second download protocol is a second version of the first download protocol.

In an embodiment, the downloading of the second download protocol comprises the downloading of an alternative download protocol used by the first version of the first download protocol to the download the second download protocol.

An embodiment provides a system comprising an update unit and a microcontroller such as described hereabove, the update unit being configured to sequentially transmit, to the microcontroller and during an update, the second download protocol and the second version of the application.

### BRIEF DESCRIPTION OF THE DRAWINGS

The foregoing features and advantages, as well as others, will be described in detail in the rest of the following disclosure of specific embodiments given as an illustration and not limitation with reference to the accompanying drawings, in which:

FIG. 1 very schematically shows in the form of blocks of a system of the type to which the embodiments apply;

FIG. 2 illustrates an example of a program update method;

FIG. 3 illustrates an example of a program update method;

FIG. 4 illustrates an example of a program update method;

FIG. 5 illustrates a program update method; and

FIG. 6 illustrates a program update method;

FIG. 7 illustrates steps of the program update method of FIG. 5;

FIG. 8 illustrates steps of the program update method of FIG. 5;

FIG. 9 illustrates steps of the program update process of FIG. 5.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

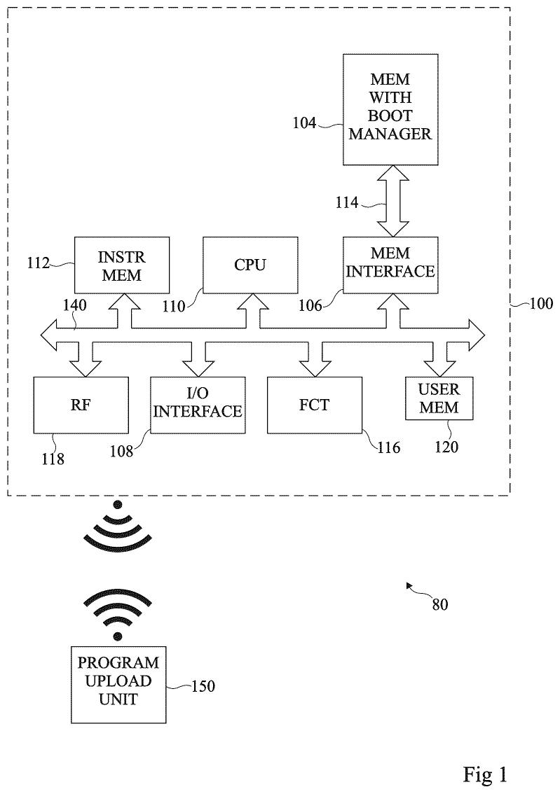

FIG. 1 very schematically shows in the form of blocks a system 80 of the type to which the embodiments apply.

System 80 comprises, for example, a microcontroller 100 capable of communicating in wireless fashion with an update device or circuit 150 (PROGRAM UPLOAD UNIT).

Microcontroller 100 comprises a non-volatile memory 104 (MEM WITH BOOT MANAGER), for example of FLASH memory type, capable of communicating, via a communication bus 114, with a non-volatile memory interface 106 (MEM INTERFACE) configured to write or read data into and from non-volatile memory 104. In an example, system programs and/or applications, such as boot programs, are implemented in memory 104. Memory 104 comprises, for example, a program configured to manage other programs stored within memory 104. These other programs are, for example, applications developed by users of the microcontroller, or wireless protocol stacks which enable, when they are executed, to implement a data communication with update unit 150. Memory 104 may further comprise a program enabling to implement the updating of data, programs, or applications present, for example, in memory 104.

Microcontroller 100 further comprises, for example, a processing unit 110 (CPU) comprising one or a plurality of processors under control of instructions stored in a system instruction memory 112 (INSTR MEM). Instruction memory 112 is, for example, a volatile random access memory (RAM). Processing unit 110 and memory 112 communicate, for example, via a system (data, address and control) bus 140. FLASH memory 104 is coupled to system bus 140 via non-volatile memory interface 106 and via bus 114. Microcontroller 100 further comprises an input/output interface 108 (I/O INTERFACE) coupled to system bus 140 to communicate with the outside.

Microcontroller 100 further comprises, for example, another memory 120 (USER MEM) of non-volatile type or of RAM type. This memory 120 is coupled to system bus 140 directly or via a memory interface (non-illustrated) having a role, for example, similar to interface 106.

Microcontroller 100 may integrate other circuits implementing other functions (for example, one or a plurality of volatile and/or non-volatile memories, other processing units), symbolized by a block 116 (FCT) in FIG. 1.

Microcontroller 100 may further integrate other circuits, such as wireless communication circuits 118 (RF) having, for example, impedance matching circuits and which are configured to be coupled to one or a plurality of antennas.

It may be necessary to update the program(s) present in memory 104.

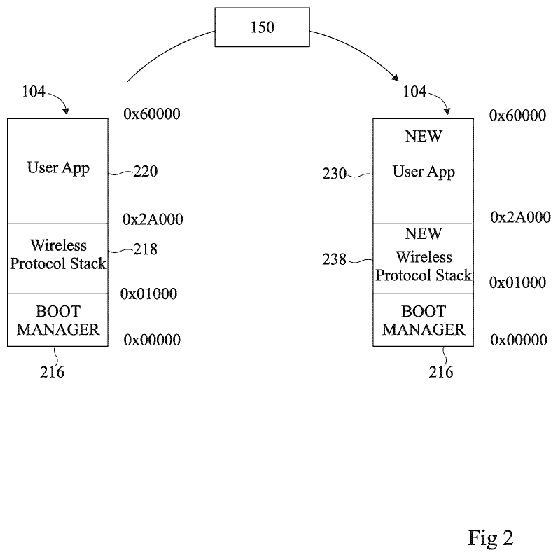

FIG. 2 illustrates an example of a program update method.

In the shown example, a wireless communication protocol program 218 (Wireless Protocol Stack) is stored between an address 0x01000 and an address 0x2A000 of memory 104, a program management program 216 (BOOT MANAGER) is stored in memory 104 between an address 0x00000 and address 0x01000, and an application 220 (User App), for example developed by a user who is a subcontractor or integrator of microcontroller 100, is stored between address 0x2A000 and address 0x60000.

When an update is requested, for example by a command received from unit 150, microcontroller 100 communicates, for example in wireless fashion, with unit 150 so that protocol 218 and/or for example also application 220 are updated and replaced in memory 104, respectively, by a new version of protocol 238 (New Wireless Protocol Stack) and a new version of application 230 (New User App). In the shown example, program manager 216 remains unchanged.

An update implementation program is required to update, in wireless fashion, programs or applications. This update implementation program, known as over-the-air (OTA), is for example stored in memory 104. In certain cases where the memory space is limited, such as for example in the case of communicating objects, it is necessary to be able to also update the update implementation program, while using it to download a new version of this implementation program from unit 150.

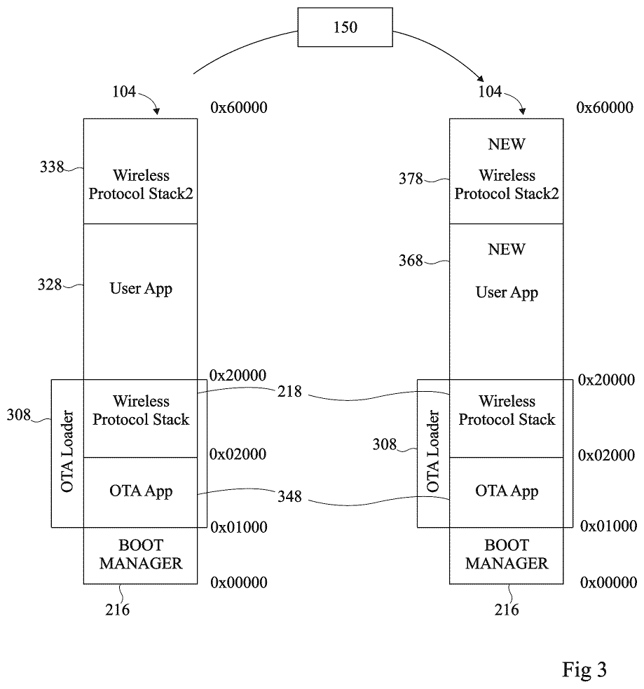

FIG. 3 illustrates an example of a program update process.

In the shown example, wireless communication protocol 218 (Wireless Protocol Stack) is stored between an address 0x02000 and an address 0x20000 in memory 104, and an update implementation program 348 (OTA App) is stored between address 0x01000 and address 0x02000. Programs 218 and 348 form a wireless update implementation program 308 (OTA Loader). Program manager 216 (BOOT MANAGER) is stored in memory 104 between address 0x00000 and address 0x01000. An application 328 (User App), including another wireless communication protocol program 338 (Wireless Protocol Stack 2) which benefits, for example, from corrected errors or improvements, is stored between address 0x20000 and address 0x60000.

When an update is requested, wireless update implementation program 308 downloads from unit 150 a new application 368 which comprises another wireless communication protocol 378 (New Wireless Protocol Stack 2) and with the help, for example, of program 216, replaces application 328 with application 368.

This example has the disadvantage that applications 328 or 368 have their own wireless communication protocol, which requires a considerable memory space, since a wireless communication protocol 218 is already present in memory 104.

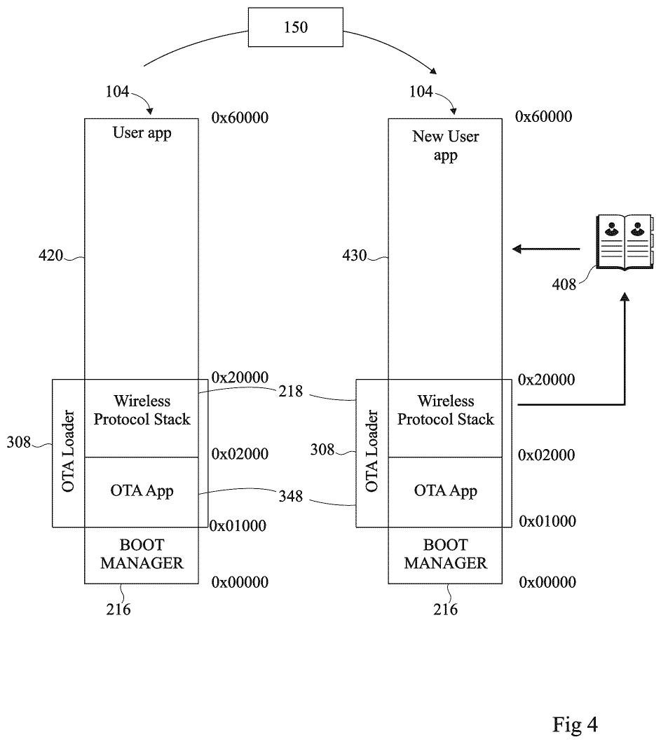

FIG. 4 illustrates an example of a program update method.

In the shown example, wireless communication protocol 218 (Wireless Protocol Stack) is stored between an address 0x02000 and an address 0x20000 in memory 104, and update implementation program 348 (OTA App) is stored between address 0x01000 and address 0x02000.Programs 218 and 348 form wireless update implementation program 308 (OTA Loader). Program manager 216 (BOOT MANAGER) is stored in memory 104 between an address 0x00000 and an address 0x01000. An application 420 (User App), built by using a catalog 408 including all the symbols of the application programming interfaces (API) located in program 308, is stored, for example, between address 0x20000 and address 0x60000.

When an update is requested, wireless update implementation program 308 downloads from unit 150 a new application 430 constructed by using the same catalog 408.

This example does not enable program 308 to call application programming interfaces from application 420, only the opposite is possible.

To overcome these disadvantages, a method is provided for updating a program in a microcontroller, the program to be updated containing a first version of a protocol for the downloading into the microcontroller and a first version of an application, and the update containing a second version of the download protocol and a second version of the application, the method comprising the following steps: erasing the first version of the application from a first region; downloading, into the first region, the second version of the download protocol by using the first version of the download protocol present in a second region; erasing the content of the second region; and downloading the second version of the application by using the second version of the download protocol.

In the text, the phrase “method for updating a program in a microcontroller” means, equivalently, “method for updating a program stored in a microcontroller”.

An advantage of this method is that it becomes possible to separate a single program into a plurality of portions, so that the portion which contains the download protocol forms an update program, functional per se without having to call elements contained in other portions of the program. It is thus possible to remove a portion of the program, for example that containing the application, without jeopardizing the possibility of downloading, in wireless fashion, an update of a program portion from unit 150 by executing the download protocol. The memory space obtained when a program portion is removed then becomes available to store the downloaded program portion.

Another advantage is that it is possible to envisage for the portion containing the download protocol to be able to call elements from another portion.

An additional advantage is that first or second versions of the application do not need to contain themselves any download protocol or wireless communication protocol.

These advantages result in a gain in the memory space necessary for updates.

The program to be updated, as well as its update, are each in the form of a binary image for example.

The embodiments thus provide executing the program to be updated or the updated program while their respective binary image comprises missing portions. In fact, the portions corresponding to the download protocol and to the application are downloaded and executed sequentially.

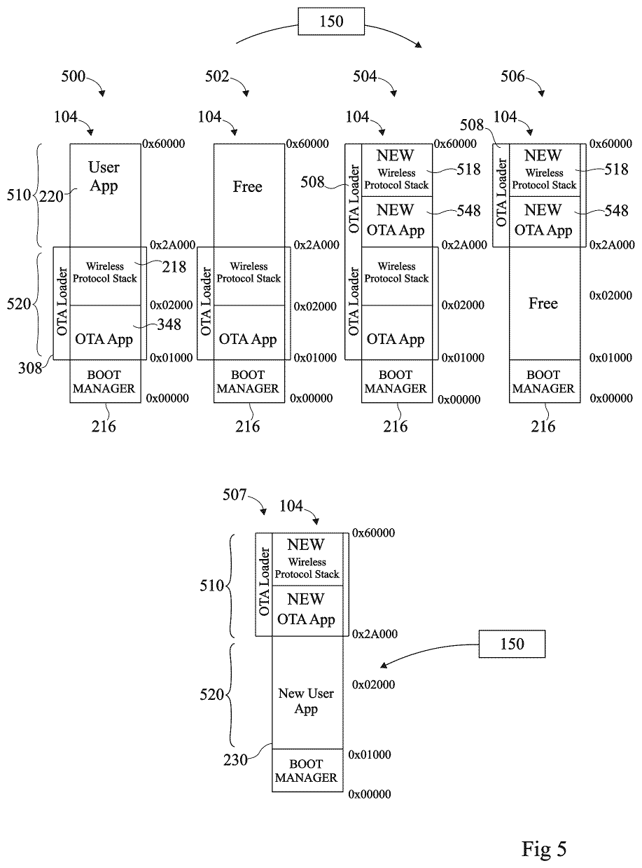

FIG. 5 illustrates a program update method.

During a step 500 of FIG. 5, the program to be updated contains a first version of a first protocol 308 for the downloading into the microcontroller and a first version of the application which is, for example, similar to application 220 (User App). The first version of the first download protocol 308 comprises wireless communication protocol 218 similar, for example, to that of FIGS. 2 to 4, as well as update implementation program 348 (OTA App) similar, for example, to that of FIG. 3 or 4. The first version of application 220 is stored, for example, in a first region 510 of memory 104. The first version of the first download protocol 308 is stored in a second region 520 of memory 104, for example. In the shown example, the first region is between address 0x2A000 and address 0x60000 of memory 104, and the second region is between address 0x01000 and address 0x2A000 of memory 104.

In an example, the program to be updated is formed of the first version of the first protocol 308 for the downloading into microcontroller and a first version of application 220. This program is, for example, in the form of a single binary image. A binary image is a sequence of binary instructions, for example in hexadecimal form, which is executable, for example, by processing unit 110. It is possible to ask processing unit 110 to execute the instructions present between two addresses in memory 104, or also to execute the instructions present in a plurality of regions, each defined by two addresses. By constructing the program to be updated in the form of a single binary image, and by grouping together in a region the instructions of download protocol 308 at least necessary for the implementation of an update, it can then be envisaged to remove a portion of the binary image which is not used during a phase of the update.

During a step 502, which is subsequent to step 500, the instructions corresponding to the first version of the application are removed, for example, by using program 216. The first region 510 of memory 104 is then free for the storage of new data.

During a step 504, which is subsequent to step 502, an update is requested. Instructions of the first version of the first download protocol 308 contained in the second region are executed with, for example, processing unit 110. The first download protocol 308 being autonomous with respect to the first region to implement update phases, a second download protocol 508 is downloaded from unit 150 and stored in the first region 510 of memory 104.

The second download protocol 508 contains, for example, a second version of wireless communication protocol 518 (New Wireless Protocol Stack) and a second version of update implementation program 548 (New OTA App).

The second download protocol 508 corresponds, for example, to a second version of the first download protocol 308.

During a step 506, subsequent to step 504, the second region of memory 104 is erased, for example with program 216, so that new data can be stored in this second region.

During a step 507, subsequent to step 506, instructions of the second download protocol 508, contained in the first region, are executed with, for example, processing unit 110. The second download protocol 508 contains all the instructions to implement the update phases. The second download protocol 508 downloads the second version of application 230 from unit 150 and then stores it in the second region 510 of memory 104.

In another example, after step 502, the second download protocol used may be an alternative download protocol different from a second version of the first download protocol 508. This alternative protocol may be smaller in size than the first and/or second versions of the first protocol 308. In this example, after step 502, the alternative download protocol is downloaded into region 510 by the first version of download protocol 308. This results in an erasing of the first version of the first download protocol 308 from region 520 and then in the downloading of the second download protocol by the alternative download protocol in region 520. The alternative download protocol is then erased from region 510. The alternative download protocol aims at allowing the download of the second version of the first download protocol, that is, the second download protocol, which will itself be in charge of downloading the new version of the application.

The use of the alternative download protocol, which is completely different, for example, from a second version of the first download protocol 308 but is smaller in size, enables to perform an update even if memory 104 is smaller than the sum of the sizes of the first and second versions of the first download protocol 308, 508. In an example, the alternative download protocol uses another radio frequency communication protocol than that which is used by the first or the second version of the first main download protocol 308, 508. In an example, the alternative protocol is a binary image which does not work with an application.

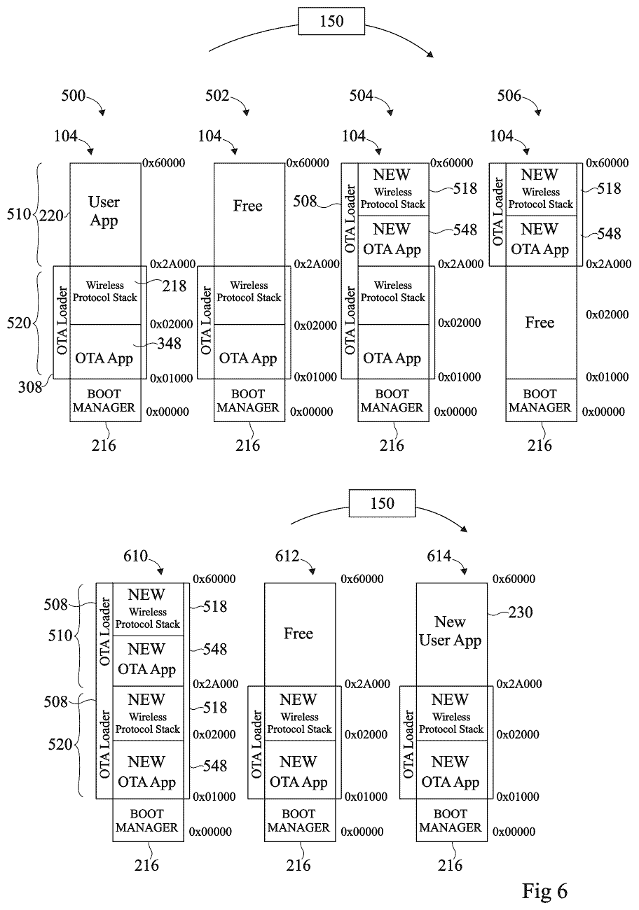

FIG. 6 illustrates a program update method. The method in the drawing comprises steps 500 to 506 of FIG. 5 and successive steps 610, 612, and 614.

In the example of FIG. 6, processing unit 110 is configured to execute, when an update is requested, the download protocol instructions which are only present in the second region 520.

During step 610, which is subsequent to step 506, program 216 copies the second version of download protocol 508, which is present in the first region, so that it is stored in the second region 520.

During step 612, the first region is, for example, erased with program 216.

During step 614, the second version of the application 230 is downloaded, from unit 150 by execution of the second version of the download protocol 508 stored in the second region 520. The second version of application 230 is then stored in the first region 510.

In the examples of FIGS. 5 and 6, the storage space in memory 104 may be equal to or greater than twice the size of download protocol 308 and/or 508.

In the case where the download protocol which is downloaded after step 502 is different from a second version of the first download protocol, then the size of the downloaded download protocol may be smaller. In this case, the size of the storage space of memory 104 is potentially smaller than twice the size of one of the versions of the first download protocol 308.

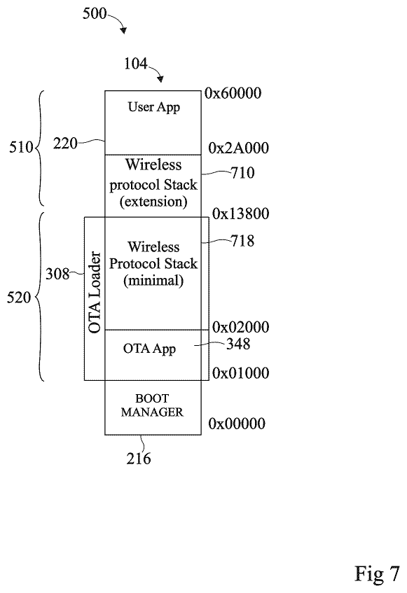

FIG. 7 illustrates steps of the program update method of FIG. 5.

The shown example illustrates, for clarity reasons, more particularly an additional implementation of step 500.

In the example of step 500 of FIG. 7, wireless communication protocol 218 now only comprises a minimum portion 718 (Wireless Protocol Stack (minimal)) of the first version of the communication protocol.

A complementary portion of the wireless communication protocol 710 (Wireless Protocol Stack (extension)) is, in this example, stored in the first region with the first version of application 220. In the shown example, the minimum portion 718 of the wireless communication protocol is stored between addresses 0x02000 and 0x13800 and the complementary portion of wireless communication protocol 710 is stored between addresses 0x13800 and 0x2A000.

This minimum portion 718 is configured so as, during update phases, not to call elements present outside of the first download protocol 308. However, during a phase when the application is running, this minimum portion 718 of the communication protocol can call application programming interfaces (APIs) of the complementary portion of wireless communication protocol 710.

The example of FIG. 7 enables to decrease the memory size taken by the wireless communication protocol and thus of the first download protocol 308 and/or of the second download protocol 508.

This may be useful in the case where the download protocol requires more memory space than the application. In this case, by removing a portion of the communication protocol 710 which is not necessary for the update steps, it is thus possible, during an update, to be able to store the second version of the download protocol in the space freed by the first version of the application.

Even though the example of FIG. 7 is only applied at step 500, those skilled in the art may apply this implementation to the other steps in FIG. 5 or also to the example shown in FIG. 6.

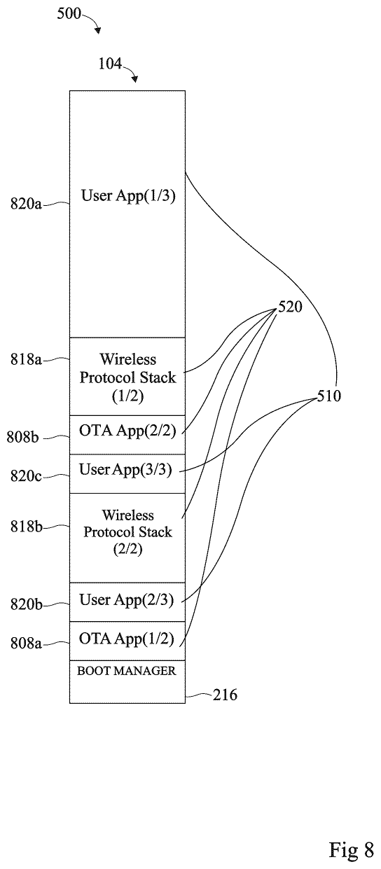

FIG. 8 illustrates steps of the program update method of FIG. 5.

More particularly, FIG. 8 shows an implementation of the step 500 of FIG. 5.

In the shown example, the first and the second regions 510, 520 and respectively the binary image which is stored therein comprise a plurality of non-contiguous segments, in other words fragments, of memory 104, each delimited by at least two addresses of memory 104. Thus, the first version of the download protocol is stored in a plurality of segments 808a (OTA App (1/2)) and 808b (OTA App (2/2)), which are non-contiguous in memory 104, in other words segments 808a and 808b do not touch each other in memory 104. The first version of the application is stored in three non-contiguous segments 820a (User App (1/3)), 820b (User App (2/3)), and 820c (User App (3/3)). The first version of the wireless communication protocol is stored in two non-contiguous segments 818a (Wireless Protocol Stack (1/2)) and 818b (Wireless Protocol Stack (2/2)).

In the example shown in FIG. 8, segment 820b lies, regarding its memory addresses, between segment 808a and segment 818b. Segment 820c lies between segment 818b and segment 808b. Segment 818a lies between segments 808b and 820a.

In the shown example, the first region 510 is formed by segments 820a, 820b, 820c and the second region 520 is formed by segments 818a, 818b, 808a, and 808b.

Although the example of FIG. 8 only shows step 500, those skilled in the art may apply this implementation to the other steps of FIG. 5, or also to the example of FIG. 6.

An advantage of the example of FIG. 8 is that it is compatible with the use of the lists of symbols used in FIG. 4. Another advantage is that it is possible to store all the secure fragments in the same region and the fragments with different security levels in other regions.

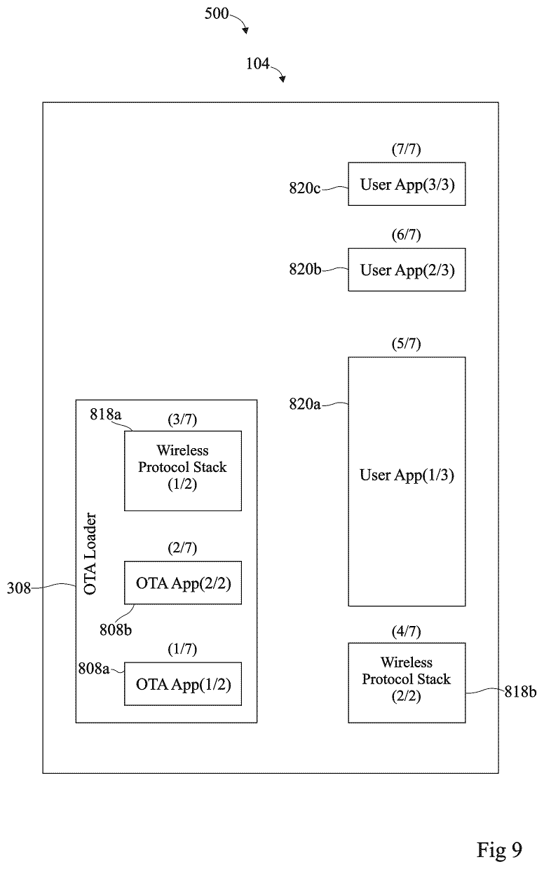

FIG. 9 illustrates steps of the program update method of FIG. 5.

More particularly, FIG. 9 shows an implementation of the step 500 of FIG. 5.

In the shown example, fragments (1/7), (2/7), and (3/7) respectively comprising segments 808a, 808b, and 818a are stored in a first region of memory 104. In the shown example, fragments (4/7), (5/7), (6/7), and (7/7) respectively comprising segments 818b, 820a, 820b, and 820c are stored in a second region of memory 104.

In the example of FIG. 9, the binary image which comprises the program to be updated is formed of different segments separated from one another. The first download protocol 308 contained in the binary image of the program to be updated must contain at least all the segments necessary to implement an update, for example wireless. However, the first download protocol 308 contained in the binary image of the program to be updated may contain segments other than those at least required to implement the update of the first version of the program.

Even though the example of FIG. 9 only shows step 500, those skilled in the art may apply this implementation to the other steps in FIG. 5, or also to the example of FIG. 6.

The described microcontroller may be used for the automotive industry. The electrification of motor vehicles generates high levels of microcontrollers in vehicles. Driving automation also comprises the use of microcontrollers.

The described microcontroller may also be used in personal electronic equipment, for example to increase the radio frequency content, in 5G connection devices or more generally in connected devices. The device is, for example, a smartphone or forms part of an internet-of-things network. The microcontroller is for example integrated in a radio frequency communication product connected by 5G, NFC, WIFI, UWB (ultra wide band), NFC (Near Field Communication), of LORA, SIGFOX, or also Bluetooth® type. The product integrating the microcontroller potentially includes filters or protections against magnetic fields or electric discharges.

Various embodiments and variants have been described. Those skilled in the art will understand that certain features of these various embodiments and variants may be combined, and other variants will occur to those skilled in the art. In particular, even though the first and second regions have been described for memory 104, other non-volatile memories may be used. Further, even though only two regions have been described, the update may involve more than two regions, as long as one or a plurality of regions comprises a version of the download protocol which enables, when it is executed alone, to download portions of the update from unit 150. Thus, a plurality of downloads separated in time of different portions of the update can be envisaged. Further, the described update methods may be repeated to allow a plurality of successive updates.

Finally, the practical implementation of the described embodiments and variants is within the abilities of those skilled in the art based on the functional indications given hereabove. In particular, regarding the download protocol which, even though it has been described in the text as being configured for a wireless update, may be adapted for wired updates. In this case, the communication with unit 150 will take place in wired fashion.

1. A method for updating a program stored in a memory of a microcontroller, the program to be updated containing a first version of a first protocol for downloading into the microcontroller and a first version of an application, and the update containing a second protocol for downloading into the microcontroller and a second version of the application, the method comprising:
erasing the first version of the application from a first region of the memory;
downloading, into the first region of the memory, the second protocol for downloading into the microcontroller by using the first version of the first protocol for downloading into the microcontroller present in a second region of the memory;
erasing the content of the second region of the memory; and
downloading the second version of the application by using the second protocol for downloading into the microcontroller.

2. The method according to claim 1, wherein downloading the second version of the application is performed into the second region of the memory.

3. The method according to claim 1, further comprising, after erasing the content of the second region and before downloading the second version of the application, transferring the content of the first region to the second region and then erasing the content of the first region.

4. The method according to claim 3, wherein downloading the second version of the application is performed into the first region.

5. The method according to claim 1, wherein said memory has a size smaller than a sum of sizes of the first and second versions of the first protocol for downloading into the microcontroller.

6. The method according to claim 1, wherein at least one of the first version of the first protocol for downloading into the microcontroller and the second protocol for downloading into the microcontroller comprises a wireless update download protocol and a wireless communication protocol.

7. The method according to claim 6, wherein the wireless update download protocol as well as the wireless communication protocol are configured so as to, when an update is requested, be fully executable without calling on elements contained in the first region.

8. The method according to claim 6, wherein the wireless communication protocol is configured so as to, during the execution of the application, call on elements from a region different from that in which it is stored.

9. The method according to claim 8, wherein said elements are portions of the wireless communication protocol which are not necessary during an update.

10. The method according to claim 1, wherein downloading the second version of the application is performed into the second region of the memory, and wherein said second region is delimited by at least two addresses in the memory.

11. The method according to claim 1, wherein downloading the second version of the application is performed into the second region of the memory, and wherein the second region comprises a plurality of non-contiguous segments of the memory, each delimited by at least two addresses in the memory.

12. The method according to claim 1, further comprising executing by a processing unit of the microcontroller, when an update is requested, download protocol instructions written in the second region.

13. The method according to claim 1, wherein downloading the second version of the application is performed into the first region, and wherein said first region is delimited by at least two memory addresses.

14. The method according to claim 1, wherein downloading the second version of the application is performed into the first region, and wherein the first region comprises a plurality of non-contiguous memory segments, each delimited by at least two memory addresses.

15. The method according to claim 1, further comprising executing by a processing unit of the microcontroller, when an update is requested, download protocol instructions written in the first region.

16. The method according to claim 1:
the program to be updated is in the form of a first binary image containing the first version of the first protocol for downloading into the microcontroller and the first version of the application; and
the update is in the form of a second binary image containing the second protocol for downloading into the microcontroller and the second version of the application.

17. The method according to claim 1, wherein the second protocol for downloading into the microcontroller is a second version of the first protocol for downloading into the microcontroller.

18. The method according to claim 1, wherein downloading the second protocol for downloading into the microcontroller comprises downloading an alternative protocol for downloading into the microcontroller used by the first version of the first protocol for downloading into the microcontroller to download the second protocol for downloading into the microcontroller.

19. A microcontroller with a memory, wherein the microcontroller is configured to implement the method of claim 1.

20. A system, comprising: an update unit and the microcontroller according to claim 19, wherein the update unit is configured to transmit, to the microcontroller and during an update, sequentially, the second protocol for downloading into the microcontroller and the second version of the application.
